(19) United States
(12) Patent Application Publication
(10) Pub. No.: US 2025/0346721 A1
(43) Pub. Date: Nov. 13, 2025

(54) FOAM COMPOSITION INCLUDING SILICONE MQ RESINS AND RELATED ARTICLES AND PROCESSES

(71) Applicant: 3M INNOVATIVE PROPERTIES COMPANY, St. Paul, MN (US)

(72) Inventors: Jenny B. Werness, St. Paul, MN (US); David W. Stegink, Mendota Heights, MN (US); Mark D. Purgett, Oakdale, MN (US); Travis Q. Gregar, Maplewood, MN (US); Carla S. Thomas, Woodbury, MN (US); Joseph A. Orrock, Woodbury, MN (US); Youhoon Kim, Woodbury, MN (US); Peter J. Elliott, Mahtomedi, MN (US); Rachel M. Lucking, Oakdale, MN (US); Sonja S. Mackey, St. Paul, MN (US); Kerstin Unverhau, Neuss (DE); James A. Bergman, St. Paul, MN (US); Jitendra S. Rathore, Woodbury, MN (US)

(21) Appl. No.: 18/870,834

(22) PCT Filed: Jun. 2, 2023
(86) PCT No.: PCT/IB2023/055705

§ 371 Date: Dec. 2, 2024

Related U.S. Application Data
(60) Provisional application No. 63/348,396, filed on Jun. 2, 2022.

(51) Int. Cl. C08G 77/32; C08J 9/00; C09J 7/38

(52) U.S. Cl. CPC C08G 77/32; C08J 9/00; C09J 7/38

(57) ABSTRACT

A foam composition includes a vehicle having voids therein and a silicone MQ resin. The vehicle comprises at least one of an organic, non-silicone containing polymer or an organic monomer. The foam composition comprises not more than 50 percent by weight water. Articles including the foam composition and processes for making the foam composition and articles are also described.

### CROSS-REFERENCE TO RELATED APPLICATION

This application claims priority to U.S. Provisional Application No. 63/348,396, filed Jun. 2, 2022, the disclosure of which is incorporated by reference in its entirety herein.

### BACKGROUND

In a foam, gas bubbles are separated from each other by thin liquid films. Typically, surfactants function by lowering the surface tension of the liquid such that a gas bubble introduced below the surface of the liquid can be maintained in the liquid. Surfactants can also stabilize foams by adsorbing at the interface of the bubbles and the liquid films and providing a barrier to coalescence of the bubbles. It is typically more challenging to form foams in organic liquids than to form aqueous foams. Some fluorinated surfactants are known to produce stable foams in organic liquids. Recently, however, there has been an industry trend away from using fluorinated surfactants.

Certain silicone surfactants have been reported as useful for foaming organic liquids in U.S. Pat. No. 4,415,615 (Esmay et al.). On the other hand, silicone MQ resins have been reported to be defoaming agents in U.S. Pat. No. 6,207,722 (Juen et al.) and in brochure “Your Technology-Siltech Chemistry”, published by Siltech Corporation, Toronto, Canada, published August 2016.

Inorganic particles are included in many foam compositions for a variety of reasons. Some of these particles function as nucleating agents. Other particles act as filler to alter the physical properties of the composition, for example, altering the rheology of the composition. Still other particles, hydrophobic fumed silica for example, have been found to function as defoaming agents. Fumed silica, which is also known as pyrogenic silica, consists of primary particles that are irreversibly bonded together in the form of aggregates, which have an average size of from 200 nm to 300 nm. U.S. Pat. No. 6,586,483 (Kolb et al.) reports a foam composition that includes surface-modified nanoparticles having a particle diameter of about 100 nanometers or less. U.S. Pat. No. 7,141,612 (Baran, Jr., et al.) reports a foam composition that includes surface-modified organic molecules such as fullerenes, dendrimers, organic polymeric microspheres, and combinations thereof.

### SUMMARY

We now report that compositions that include silicone MQ resins are capable of forming a persistent foam in an organic liquid. Compositions that include a silicone MQ resin surprisingly are capable of forming a persistent foam even though silicone MQ resins have been reported to be defoaming agents. In some embodiments, compositions that include silicon MQ resins and a poly(alkyleneoxide)-modified polydimethylsiloxane or an alkoxylated alcohol are surprisingly more capable of forming a persistent foam than compositions that include either the poly(alkyleneoxide)-modified polydimethylsiloxane or the alkoxylated alcohol alone although poly(alkyleneoxide)-modified polydimethylsiloxane and alkoxylated alcohols are reported to be useful as surfactants.

In one aspect, the present disclosure provides a foam composition that includes a vehicle having voids therein and a silicone MQ resin. The vehicle includes at least one of an organic, non-silicone containing polymer or an organic monomer. The foam composition includes not more than 50 percent by weight water.

In another aspect, the present disclosure provides an adhesive tape (for example, a pressure-sensitive adhesive tape) including an above-described foam composition.

In another aspect, the present disclosure provides an article that includes an above-described foam composition. The article can be, for example, a gasket or automobile body molding.

In another aspect, the present disclosure provides a process for making the above-described foam composition that includes introducing a foaming agent into a composition comprising the vehicle and the silicone MQ resin to form voids in the composition.

In another aspect, the present disclosure provides a process of making a tape where the process includes foaming an adhesive composition that includes a silicone MQ resin and a vehicle including at least one of an organic, non-silicone containing polymer or an organic monomer and subsequently applying the composition to a substrate.

As used herein:

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5).

The term “acrylic” refers to both acrylic and methacrylic polymers, oligomers, and monomers.

The term “(meth)acrylate” with respect to a monomer, oligomer, or polymer means a vinyl-functional alkyl ester formed as the reaction product of an alcohol with an acrylic or a methacrylic acid. “(Meth)acrylate” includes, separately and collectively, methacrylate and acrylate.

“Alkyl group” and the prefix “alk-” are inclusive of both straight chain and branched chain groups having up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above.

“Arylalkylene” refers to an “alkylene” moiety to which an aryl group is attached.

“Aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups, examples of which include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

A “unit” of a polymer or oligomer is a segment of a polymer or oligomer derived from a single monomer.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked. Thermoset polymers are crosslinked.

The term “persistent foam” refers to the presence of gas voids in a composition for a period of at least five minutes after the composition has been foamed.

The term “hydrocarbon” refers to compounds that have only carbon and hydrogen atoms. In relation to hydrocarbon alcohols or hydrocarbon surfactants, the descriptor “hydrocarbon” excludes the hydroxyl group or the hydrophilic group of the surfactant.

The term “ceramic” refers to glasses, crystalline ceramics, glass-ceramics, and combinations thereof.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### DETAILED DESCRIPTION

The foam composition of the present disclosure and/or useful in the processes of the present disclosure includes a silicone MQ resin. A silicone MQ resin is an organosilicon polymer made from structural units referred to as M units represented by formula (R)₃SiO_{1/2} and Q units represented by formula SiO_{4/2}, in which Si is silicon, O is oxygen and R is either hydrogen or an aliphatic or aromatic organic group. Thus, silicone MQ resins comprise silicon atoms bonded to one oxygen atom and silicon atoms bonded to four oxygen atoms. A representative structure of a silicone MQ resin is shown in formula I, below.

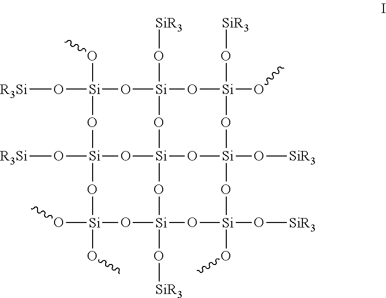

Suitable R substituents include hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, —NH—, —N(alkyl)-, —S—, —Si—, or combination thereof, and wherein aryl, arylene, and heterocyclylene are unsubstituted or substituted by at least one alkyl, alkoxy, halogen, or combination thereof. R groups can be selected independently from each other. In some embodiments, each R group is the same. In some embodiments, R is not fluorinated. In some embodiments, R is not halogenated. In some embodiments, R is not hydrogen. In some embodiments, each R is independently hydrogen, alkyl, aryl, or alkyl at least one of interrupted by at least one catenated —O— group or arylene or terminated by aryl. Suitable alkyl groups for R typically have 1 to 20, 1 to 18, 1 to 12, 1 to 10, 1 to 6, or 1 to 4 carbon atoms. Examples of useful alkyl groups include methyl, ethyl, isopropyl, n-propyl, n-butyl, iso-butyl, and octadecyl. In some embodiments, each R is independently alkyl having up to 18 (in some embodiments, up to 4, 3, or 2) carbon atoms, phenyl, benzyl, or C₆H₅C₂H₄—. In some embodiments, each R is independently methyl, phenyl, C₆F₁₃C₂H₄—, or octadecyl. In some embodiments, each R is independently alkyl. In some embodiments, each R is independently methyl or phenyl. In some embodiments, each R is methyl; in these embodiments, the silicone MQ resin comprises methyl groups. In some embodiments, the silicone MQ resin is not fluorinated. In some embodiments, the silicone MQ resin is not halogenated.

The ratio of the M units to Q units influences the properties of a silicone MQ resin. Silicone MQ resins that have a M:Q ratio greater than 1 are typically liquids at room temperature. Silicone MQ resins that have a M:Q ratio of 1 or lower are typically solids at room temperature. As used herein, “room temperature” refers to 20° C. to 25° C. In some embodiments, the silicone MQ resin has an M:Q ratio of at least 0.3:1, 0.4:1, 0.5:1, 0.6:1, 0.7:1, 0.8:1, 0.9:1, 1:1, 1.1:1, 1.2:1, 1.3:1, 1.4:1, or 1.5:1. In some embodiments, the silicone MQ resin has an M:Q ratio of at least 0.8:1, 0.9:1, 1:1, 1.1:1, or 1.2:1. The maximum M:Q ratio is 4:1. For silicone MQ resins, the M:Q ratio is typically not more than 3:1, in some embodiments, not more than 2.9:1, 2.8:1, 2.7:1, 2.6:1, 2.5:1, 2.4:1, 2.3:1, 2.2:1, 2.1:1, or 2:1. For the purposes of this disclosure, the M:Q ratio is determined by NMR spectroscopy using the method described in the Examples, below.

A silicone MQ resin can be prepared by a reaction of a one or more compounds represented by formula (R)₃—Si—R¹ and one or more compounds represented by formula (R¹)₄Si, wherein R is as defined above in any of its embodiments, and R¹ is a hydrolyzable group. The term “hydrolyzable group” refers to a group that can react with water under conditions of atmospheric pressure. The reaction with water may optionally be catalyzed by acid or base. Suitable hydrolyzable groups include halogen (e.g., iodo, bromo, chloro); alkoxy (e.g., —O-alkyl), aryloxy (e.g., —O-aryl), acyloxy (e.g., —O—C(O)-alkyl), amino (e.g., —N(R^{A})(R^{B}), polyalkyleneoxy; and oxime (e.g., —O—N═C—(R^{A})(R^{B}), wherein each R^{A} or R^{B} is independently hydrogen or alkyl). In some embodiments, each R¹ is independently halogen or alkoxy optionally substituted by halogen. In some embodiments, each R¹ is independently chloro or alkoxy having up to 12 (or up to 6 or 4) carbon atoms. In some embodiments, each R¹ is independently methoxy or ethoxy. When the compounds of formula (R)₃—Si—R¹ and (R¹)₄Si react, R¹ is converted to a hydrolyzed group, such as —OH, during hydrolysis. The Si—OH groups react with each other to form silicone-oxygen linkages. Hydrolysis and condensation can be carried out by conventional methods, for example, by heating the compound of formula R—Si(R¹)₃ and optionally R²—Si(R¹)₃ in water optionally in the presence of acid or base.

After hydrolysis and condensation, typically-OH groups are present in the silicone MQ resin. The —OH groups can be further reacted with an end-capping agent to convert the hydrolyzed group, e.g., —OH, to —OSi(R)₃. Suitable end-capping agents include those having formulas R¹—Si(R)₃ and O [Si(R)₃]₂, wherein R¹ is as defined above in any of its embodiments, for example. Suitable end-capping agents also include those having formulas H—Si(R)₃, which can react with hydroxyl groups in the present of transition metal catalysts (e.g., palladium and platinum catalysts). The silicone MQ resin comprises further groups having the formula —Si(R)₃ after end-capping, wherein R is as defined above in any of its embodiments, independently from other R groups in the silicone MQ resin. In some embodiments, the silicone MQ resin has a hydroxyl content in a range from 185 to 1840 milliequivalents per kilogram (meq/kg). In some embodiments, the silicone MQ resin has a hydroxyl content in a range from 500 to 1000 milliequivalents per kilogram (meq/kg). For the purposes of this disclosure, the hydroxyl content is determined by NMR spectroscopy using the method described in the Examples, below, for the determining the MQ ratio.

Depending on M:Q stoichiometry, synthetic preparation, and end-capping, silicone MQ resins can take a variety of polycyclic structures and have a variety of properties, including solubility in organic vehicles. Although formula I is shown as having an organized structure at least in the central portion, it should be understood that the silicone MQ resin may have a more random structure. Thus, silicone MQ resins useful for practicing the present disclosure include three-dimensional and branched random copolymers.

Silicone MQ resins can be obtained from a variety of commercial sources, for example, from Siltech, Corporation, Toronto, Ontario, Canada, under the trade designation “SILMER Q”; from Dow Chemical Company, Midland, Michigan, under the trade designation “DOWSIL”, from Wacker Chemie, Munich, Germany, from Momentive Performance Materials, Waterford, New York, under the trade designation “SILGRIP”, from BYK-Chemie, Wesel, Germany, and from Gelest, Inc., Morrisville, Pennsylvania. Silicone MQ resins have been reported to provide release properties, lubricity, tack, softness, and/or repellency. Additionally, MQ resins are explicitly reported as “defoamers” and “antifoamers”. Silicone MQ resins are generally not known as surfactants. In some embodiments, the silicone MQ resins are free of alkyloxy groups such as those represented by formula —(OR²)ₙ—OR³, in which n, R², and R³ are as defined below in any of their embodiments.

In some embodiments, the silicone MQ resin is present in the foam composition in a range from 0.1 weight percent to 10 weight percent, based on the total weight of the foam composition. In some embodiments, the silicone MQ resin is present in the foam composition in a range from 0.1 weight percent to 5 weight percent, or in a range from in a range from 0.5 weight percent to 3 weight percent, based on the total weight of the foam composition. The silicone MQ resin may be present in the foam composition in an amount of at least 0.1, 0.2, 0.3, 0.4, or 0.5 weight percent and up to 10, 5, 4, or 3 weight percent, based on the total weight of the foam composition.

In some embodiments, the foam composition of the present disclosure or made by the process of the present disclosure further includes a nonionic surfactant. In some embodiments, the foam composition of the present disclosure or made by the process of the present disclosure further includes a poly(alkyleneoxide)-modified polydimethylsiloxane. A polydimethylsiloxane is an organosilicon polymer made from structural units referred to as D units represented by formula (R)₂SiO_{2/2}, in which Si is silicon, O is oxygen and R is a methyl group. In some embodiments, the poly(alkyleneoxide)-modified polydimethylsiloxane is not fluorinated. In some embodiments, the poly(alkyleneoxide)-modified polydimethylsiloxane is not halogenated. Polydimethylsiloxanes include repeating divalent units represented by formula II:

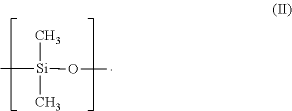

A poly(alkyleneoxide)-modified polydimethylsiloxane further includes terminal units represented by formula -Q-(OR²)ₙ—OR³, divalent units represented by formula III:

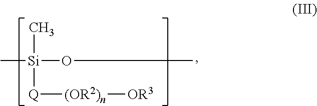

or a combination thereof, wherein each Q is independently alkylene, arylene, or alkylene that is at least one of interrupted or terminated by aryl, each of which is optionally at least one of interrupted or terminated by at least one ether (i.e., —O—), thioether (i.e., —S—), amine (i.e., —NR⁴—), amide (i.e., —N(R⁴)—C(O)— or —C(O)—N(R⁴)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R⁴)N—C(O)—O— or —O—C(O)—N(R⁴)—, thiocarbamate (i.e., —N(R⁴)—C(O)—S— or —S—C(O)—N(R⁴)—, urea (i.e., —(R⁴)N—C(O)—N(R⁴)—), thiourea (i.e., —(R⁴)N—C(S)—N(R⁴)). In any of these groups that include an R⁴, R⁴ is hydrogen, alkyl, aryl, or arylalkylenyl, wherein aryl and arylalkylenyl are unsubstituted or substituted by at least one alkyl, alkoxy, or combination thereof. In some embodiments, R⁴ is hydrogen or alkyl, for example, having 1 to 4 carbon atoms (e.g., methyl, ethyl, n-propyl, isopropyl, n-butyl, isobutyl, or sec-butyl). In some embodiments, R⁴ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—). In some embodiments, Q is alkylene having 1 to 10, 1 to 6, 1 to 4, 1 to 3, or 1 to 2 carbon atoms. For suitable poly(alkylene oxide) groups, each OR² is independently —OCH₂CH₂—, —OCH(CH₃)CH₂—, —OCH₂CH₂CH₂—, —OCH₂CH(CH₃)—, —OCH₂CH₂CH₂CH₂—, —OCH(CH₂CH₃)CH₂—, —OCH₂CH(CH₂CH₃)—, and —OC(CH₃)₂CH₂—. In some embodiments, each OR² is independently-OCH₂CH₂—, —OCH(CH₃)CH₂— or —OCH₂CH(CH₃)—. In some embodiments, each OR² is independently-OCH₂CH₂—. Each n is independently a value from 5 to 300 (in some embodiments, from 10 to about 250, or from 20 to about 200). For suitable poly(alkylene oxide) groups, each R³ is hydrogen, alkyl, acyl, aryl, or arylalkylenyl, wherein aryl and arylalkylenyl are unsubstituted or substituted by at least one alkyl, alkoxy, or combination thereof. In some embodiments, R³ is hydrogen, alkyl, for example, having 1 to 4 carbon atoms (e.g., methyl, ethyl, n-propyl, isopropyl, n-butyl, isobutyl, or sec-butyl), or acyl, for example, having 2 to 4 carbon atoms (e.g., acetyl, propionyl, or butyryl). In some embodiments, R³ is acetyl, methyl, or hydrogen. In some embodiments, R³ is hydrogen or acetyl.

In some embodiments, the poly(alkyleneoxide)-modified polydimethylsiloxane useful in the foam composition of the present disclosure can be represented by formula IV:

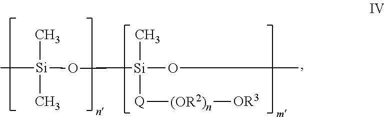

which may or may not include a terminal unit represented by formula -Q-(OR²)ₙ—OR³, wherein each R², R³, Q, and n are independently as defined above in any of their embodiments, and n′+m′ is in a range from 10 to 500, 10 to 400, 10 to 300, 12 to 300, 13 to 300, 13 to 200, 10 to 100, 10 to 50, or 10 to 30. Such values of n′+m′ provide poly(alkyleneoxide)-modified polydimethylsiloxanes having number average molecular weights of up to about 50,000, 40,000, 30,000, 25,000, 15,000, 10,000, or 5,000 grams per mole. Typically, the ratio of n′ to m′ is greater than 1:1 (in some embodiments, at least 2:1 or 3:1, or 5:1). In some embodiments, the poly(alkyleneoxide)-modified polydimethylsiloxane as described herein in any of its embodiments has a number average molecular weight of at least 750 grams per mole, at least 900 grams per mole, or at least 1000 grams per mole. In some embodiments, the poly(alkyleneoxide)-modified polydimethylsiloxane as described herein in any of its embodiments has a number average molecular weight of not more than 50,000, 40,000, 30,000, 25,000, 15,000, 10,000, or 5,000 grams per mole. Polysiloxanes disclosed herein typically have a distribution of molecular weights. Although formula IV is shown as a block copolymer, it should be understood that the divalent units of formulas II and III can be randomly positioned in the copolymer. Thus, polysiloxanes useful for practicing the present disclosure also include random copolymers.

The number of repeating units and the molecular weights of polysiloxanes can be determined, for example, by nuclear magnetic resonance (NMR) spectroscopy using techniques known to one of skill in the art. Molecular weights, particularly for higher molecular-weight materials, including number average molecular weights and weight average molecular weights, can also be measured, for example, by gel permeation chromatography (i.e., size exclusion chromatography) using techniques known to one of skill in the art. For the purposes of this disclosure, the number average molecular weight of the poly(alkyleneoxide)-modified polydimethylsiloxane is determined by NMR spectroscopy using the method described in the Examples, below.

In some embodiments, the foam composition of the present disclosure or made by the process of the present disclosure further includes an alkoxylated alcohol. In some embodiments, the alcohol has a linear or branched hydrocarbon chain with 10 to 20 carbon atoms. Suitable alkoxylated alcohols include those represented by formula R¹⁰—(OR²)ₙ, wherein R² and n are as described above in any of their embodiments, and R¹⁰ linear or branched alkyl or alkenyl chain having 10 to 20 carbon atoms. The alkoxylated alcohol may include at least one of polyoxyethylene (POE) and polyoxypropylene (POP) units (i.e., where OR² is independently-OCH₂CH₂—, —OCH(CH₃)CH₂— or —OCH₂CH(CH₃)— and n is 1 to 100, 3 to 50, or 5 to 20) in a random or block form. Suitable examples include POE (4 to 11) lauryl ether, POE (10 to 20) cetyl ether, POE (4 to 20) oleyl ether, POP (5) lauryl ether, POP (7) cetyl ether, POP (10) oleyl ether, and POE (3) POP (5) lauryl ether, wherein the numerical values in parentheses of POE and POP indicate the number of units of oxyethylene unit and oxypropylene unit. In some embodiments, the alkoxylated alcohol is an alcohol ethoxylate. Suitable alkoxylated alcohols include a five-mole ethoxylate of a linear, primary 12-14 carbon number alcohol available, for example, from Huntsman Corporation, The Woodlands, Tex., under the trade designation “SURFONIC L24-5” Surfactant and an alcohol ethoxylate available, for example, from Dow Chemical Company under the trade designation “ECOSURF EH-6”. In some embodiments, the alkoxylated (e.g., ethoxylated, propoxylated, or combinations thereof) alcohol is an alkoxylated branched alcohol, in some embodiments, an alkoxylated Guerbet alcohol. An example of a C₁₀ Guerbet alcohol is represented by formula

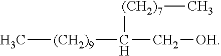

Suitable alkoxylated Guerbet alcohols include those available from BASF Corporation, Florham Park, N.J., under the trade designation “LUTENSOL XP”.

In some embodiments, the silicone MQ resin and at least one of the poly(alkyleneoxide)-modified polydimethylsiloxane or alkoxylated alcohol is present in the foam composition in a combined amount from 0.1 weight percent to 10 weight percent, based on the total weight of the foam composition. In some embodiments, the silicone MQ resin and at least one of the poly(alkyleneoxide)-modified polydimethylsiloxane or the alkoxylated alcohol is present in the foam composition in a combined amount from 0.1 weight percent to 5 weight percent, or in a range from in a range from 0.5 weight percent to 3 weight percent, based on the total weight of the foam composition. The silicone MQ resin and at least one of the poly(alkyleneoxide)-modified polydimethylsiloxane or the alkoxylated alcohol may be present in the foam composition in a combined amount of at least 0.1, 0.2, 0.3, 0.4, or 0.5 weight percent and up to 10, 5, 4, or 3 weight percent, based on the total weight of the foam composition. In some embodiments, the foam composition is free of fluorinated surfactants.

The foam composition of the present disclosure and/or useful in the processes of the present disclosure includes a vehicle having voids therein. The vehicle comprises at least one of an organic, non-silicone containing polymer or an organic monomer. In some embodiments, the vehicle comprises an organic polymer and an organic monomer used to make the organic polymer. The voids may be present at the surface of the composition, dispersed throughout the composition, or a combination thereof. For some applications, the voids are dispersed uniformly throughout the composition. The voids generally include at least one gas; therefore, they may be referred to as gas voids or bubbles. In some embodiments, the foam composition includes a cellular structure in which the voids are in the form of closed cells. In some embodiments, the foam composition is an open cell foam.

The vehicle of the foam composition of the present disclosure or made by one of the processes of the present disclosure can include a variety of components and may be in the form of a solid, liquid, or a combination thereof. The vehicle may be selected based upon the desired properties of the foam composition (e.g., tack, stiffness, hardness, density, volume, transparency, flexibility, conformability, resilience, creep, strength, modulus, elongation, chemical resistance, temperature resistance, environmental resistance, and compressibility). In some embodiments, at the time of foaming, the vehicle is a liquid and may be, for example a solution, an emulsion, a suspension, a dispersion, a syrup, or a melt. In some embodiments, the vehicle comprises an organic liquid. Useful examples of organic liquids include acids, alcohols, ketones, aldehydes, amines, ethers, hydrocarbons, halocarbons, monomers, oligomers, and polymers.

In some embodiments, the vehicle includes water. In some embodiments, the vehicle excludes water. The foam composition comprises not more than 50, 40, 30, 20, 10, 5, or 1 percent by weight water.

Examples of useful organic vehicles include organic polymers. Organic polymers suitable for the vehicle include natural and synthetic rubber resins including thermosettable rubbers as well as thermoplastic rubbers and elastomers such as nitrile rubbers (e.g, acrylonitrile-butadiene), polyisoprene rubber, polychloroprene rubber, polybutadiene rubber, butyl rubber, ethylene-propylene-diene monomer rubbers (EPDM), Santoprene® polypropylene-EPDM elastomers, ethylene-propylene rubber, styrene-butadiene copolymers, styrene-isoprene copolymers, styrene-butadiene-styrene rubber, styrene-isoprene-styrene rubber, styrene-ethylene-butylene-styrene rubber, styrene-ethylene-propylene-styrene rubber, polyisobutylene rubber, ethylene vinyl acetate rubbers, polymethacrylate rubbers, polyacrylate rubbers (e.g., copolymers of isooctyl acrylate and acrylic acid or any of those described in further detail below), polyesters, polyether esters, polyvinyl ethers, polyurethanes, and blends and copolymers thereof. Useful copolymers include linear, radial, star and tapered block copolymers and combinations thereof.

Other elastomers suitable for the vehicle include fluoroelastomers (e.g., polytrifluoroethylene, polyvinylidene fluoride, hexafluoropropylene, and fluorinated ethylene-propylene copolymers), fluorosilicones and chloroelastomers (e.g., chlorinated polyethylene), and combinations thereof.

Further examples of organic polymers suitable for the vehicle include thermoplastic resins such as polyacrylonitrile, acrylonitrile-butadiene-styrene, styrene-acrylonitrile, cellulose, chlorinated polyether, ethylenevinylacetate, fluorocarbons (e.g., polychlorotrifluoroethylene, polytetrafluoroethylene, fluorinated ethylene-propylene, and polyvinylidene fluoride), polyamides (e.g., polycaprolactam, polyhexamethylene adipamide, polyhexamethylene sebacamide, polyundecanoamide, polylauroamide and polyacrylamide), polyimides (e.g., polyetherimide), polycarbonate, polyolefins (e.g., polyethylene, polypropylene, polybutene and poly-4-methyl pentene), polyalkylene terephthalates (e.g., polyethyleneterephthalate), polyalkylene oxides (e.g., polyphenylene oxide), polystyrene, polyurethane, polyisocyanurates, vinyl polymers (e.g., polyvinyl chloride, polyvinyl acetate, polyvinyl alcohol, polyvinyl butyral, polyvinylpyrrolidone, polyvinylidene chloride), and combinations thereof.

Further examples of organic polymers suitable for the vehicle include thermosettable resins such as polyesters and polyurethanes and hybrids and copolymers thereof including acylated urethanes and acylated polyesters, amino resins (e.g., aminoplast resins, alkylated urea-formaldehyde resins, melamine-formaldehyde resin), acrylate resins (e.g., polyacrylates and polymethacrylates, vinyl acrylates, acrylated epoxies, acrylated urethanes, acrylated polyesters, acrylated acrylics, acrylated polyethers, and acrylated oils), alkyd resins such as urethane alkyd resins, polyester resins, reactive urethane resins, phenolic resins (e.g., resole resins, novolac resins, and phenol-formaldehyde resins), phenolic/latex resins, epoxy resins (e.g., bisphenol epoxy resins, aliphatic and cycloaliphatic epoxy resins, epoxy/urethane resin, and epoxy/acrylate resin), isocyanate resins, isocyanurate resins, reactive vinyl resins, and mixtures thereof.

In some embodiments, the vehicle comprises at least one of an isocyanate, a polyurethane, or a polyurea. A wide variety of isocyanates and polyols and polyurethanes made therefrom can be used in the foam composition of the present disclosure. In some embodiments, the foam composition is a polyurethane foam and the process for making the foam composition is a process for making a polyurethane foam.

In some embodiments, the vehicle comprises an organic polymer that is other than a silicone or silicone-containing polymer. In some embodiments, the vehicle comprises an organic polymer that is other than an acrylated silicone, a silicone-containing polyurethane, or epoxy/silicone resin.

In some embodiments, the vehicle comprises an adhesive composition such as pressure-sensitive, hot melt, thermoset, and thermoplastic adhesive compositions. The vehicle can include any pressure-sensitive adhesive composition including solvent-coatable, hot-melt-coatable, radiation-curable (e.g., with E-beam, actinic radiation such as visible and UV, and thermal), and combinations thereof. Pressure-sensitive adhesive (PSA) compositions suitable for the vehicle include tackified rubber adhesives (e.g., natural rubber, olefins, polyisoprenes, polybutadiene, polyurethanes, styrene-isoprene-styrene and styrene-butadiene-styrene block copolymers and other elastomers), and tackified and untackified acrylic adhesive compositions. In some embodiments, the PSA composition is not and/or does not comprise a silicone rubber.

In some embodiments, the vehicle comprises at least one of an acrylic polymer (e.g., an acrylic PSA) or precursor thereof (e.g., first and optionally second acrylic monomers). In some embodiments, the vehicle comprises a copolymer of an alkyl ester of acrylic acid as a first monomer and, optionally, a minor portion of a second monomer. Useful acrylic acid esters include acrylic or methacrylic acid esters of a monohydric alcohol having from 1 to 20 carbon atoms. Suitable acrylic or methacrylic acid esters of a monohydric alcohol include those represented by Formula V:

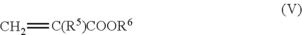

wherein R⁵ is hydrogen or a methyl group and R⁶ is an alkyl group having 4 to 20, 4 to 18, 4 to 16, 4 to 12, 6 to 12, or 8 to 12 carbon atoms, which may be linear, branched, cyclic, or polycyclic. Examples of suitable monomers represented by Formula V include n-butyl acrylate, s-butyl acrylate, t-butyl acrylate, n-pentyl acrylate, isopentyl acrylate, hexyl acrylate, cyclohexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, lauryl acrylate, stearyl acrylate, isostearyl acrylate, isobornyl acrylate, 2-methylbutyl acrylate, 4-methyl-2-pentyl acrylate, octadecyl acrylate, 2-propylheptyl acrylate, methacrylates of the foregoing acrylates, and combinations thereof. Further examples of suitable monomers for a vehicle include mixtures of at least two or at least three structural isomers of a secondary alkyl (meth)acrylate of Formula (VI):

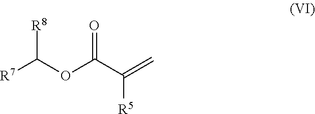

wherein R⁷ and R⁸ are each independently a C₁ to C₃₀ saturated linear alkyl group; the sum of the number of carbons in R⁷ and R⁸ is 7 to 31; and R⁵ is hydrogen or a methyl group. The sum of the number of carbons in R⁷ and R⁸ can be, in some embodiments, 7 to 27, 7 to 25, 7 to 21, 7 to 17, 7 to 11, or 7. Methods for making and using such monomers and monomer mixtures are described in U.S. Pat. No. 9,102,774 (Clapper et al.).

Second monomer units can be more polar than the first monomer units. Examples of suitable second monomers useful for preparing acrylic PSAs include an acrylic acid (e.g., acrylic acid, methacrylic acid, itaconic acid, maleic acid, and fumaric acid), an acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a hydroxyl- or amino-substituted acrylate (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl pyrrolidone, N-vinyl caprolactam, an alpha-olefin, a vinyl ether, a vinyl ester (vinyl acetate, vinyl benzoate, vinyl 4-tert-butylbenzoate, vinyl cinnamate, vinyl decanoate, vinyl neodecanoate, vinyl neononanoate, vinyl pivalate, vinyl propionate, vinyl stearate, and vinyl valerate), an allyl ether, a styrenic monomer (e.g., 4-tert-butoxystyrene, 4-(tert-butyl) styrene, 4-chloromethylstyrene, chloromethylstyrene, 3-chlorostyrene, 2 (diethylamino)ethylstyrene, 2-methylstyrene, 4-methylstyrene, 4-nitrostyrene, and 4 vinylbenzoic acid), a maleate, and combinations thereof. In some embodiments, the acrylic polymer comprises second monomer units of at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid. Other useful monomers that may be in acrylate-based adhesive compositions include ethylenically-unsaturated monomers such as methyl methacrylate, ethyl methacrylate, propyl methacrylate, and combinations thereof.

Crosslinked acrylic PSAs may be made, for example, by including one or more polyfunctional crosslinking monomers in the formulation. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Crosslinking can also be achieved without a crosslinking agent by using high energy radiation such as gamma or electron beam radiation.

Typically, the alkyl ester of acrylic acid (e.g., first monomer represented by formula V or VI) is used in an amount of 75 weight percent to 100 weight percent based on a total weight of monomers to make the acrylic polymer, and a second monomer as described above is used in an amount of 0 weight percent to 25 weight percent based on a total weight of monomers to make the acrylic polymer. In some embodiments, the first monomer is used in an amount of at least 80, 85, 90, 92, 95, 97, 98, or 99 percent by weight based on the total weight of the monomers, and the second monomer is used in an amount of up to 20, 15, 10, 8, 5, 3, 2, or 1 percent by weight based on the total weight of the monomers. These percentages also reflect the percentages of the various monomer units in the acrylic polymer. When present, the polyfunctional crosslinking monomer can be used in an amount of 0.002 to 2 parts per hundred parts of the monofunctional monomers, for example from about 0.01 to about 0.5 parts or from about 0.05 to 0.15 parts per hundred parts of the monofunctional monomers.

The vehicle can include any of these monomers, a polymer made from any of these monomers, or a combination thereof.

When the vehicle includes monomers, polymerization of the monomers can be achieved by various conventional free radical polymerization methods (e.g., solvent polymerization, emulsion polymerization, suspension polymerization, and bulk polymerization), which can be chemically, thermally, and/or radiation initiated. Polymerization can be initiated by actinic radiation (e.g., visible or ultraviolet light), electron beam radiation, and combinations thereof.

The vehicle can also include free-radical initiators such as thermal initiators and photoinitiators. Certain photoinitiators, when used, can be consumed upon reaction with light and may not be present in the foam composition of the present disclosure. In some embodiments, the foam composition further comprises a photoinitiator or a fragment thereof. Any suitable photoinitiator may be useful in the foam composition comprising at least one acrylic monomer, for example, first and second acrylic monomers as described above in any of their embodiments. Suitable photoinitiators include type I or type II photoinitiators. Suitable photoinitiators may include acetophenones, benzilketal, alkylaminoacetophenones, benzoyl phosphine oxides, benzoin ethers, benzophenones, and benzoylformate esters. In some embodiments, the free radical photoinitiator is a type I (cleavage-type) photoinitiator. Cleavage-type photoinitiators include acetophenones, alpha-aminoalkylphenones, benzoin ethers, benzoyl oximes, acyl (e.g., benzoyl) phosphine oxides, acyl (e.g., benzoyl) phosphinates, and mixtures thereof.

Examples of useful benzoin ethers include benzoin methyl ether and benzoin butyl ether. Examples of suitable acetophenone compounds include 4-diethylaminoacetophenone, 1-hydroxycyclohexyl phenyl ketone, 2-benzyl-2 dimethylamino-4′-morpholinobutyrophenone, 2-hydroxy-2-methyl-1-phenylpropan-1 one, and 2,2-dimethoxy-1,2-diphenylethan-1-one. Example of suitable acyl phosphine oxide, acyl phosphinate, and acyl phosphonate compounds include bis(2,6-dimethoxybenzoyl)-2,4,4-trimethylpentyl phosphine oxide, phenylbis(2,4,6-trimethylbenzoyl) phosphine oxide, ethyl phenyl(2,4,6-trimethylbenzoyl)phosphinate, (2,4,6-trimethylbenzoyl)diphenylphosphine oxide, dimethyl pivaloylphosphonate, and poly(oxy-1,2-ethanediyl), α,α′,α″-1,2,3-propanetriyltris [ω-[phenyl(2,4,6-trimethylbenzoyl)phosphinyl]oxy]. Many photoinitiators are available, for example, from BASF, Vandalia, Ill. under the trade designation “IRGACURE”, from IGM Resins, Waalwijk, Netherlands, under the trade designations “OMNIRAD” and “ESACURE”. Two or more of any of these photoinitiators may also be used together in any combination. The photoinitiator may be selected, for example, based on the desired wavelength for curing and compatibility with the composition.

Examples of suitable thermal initiators include peroxides (e.g., benzoyl peroxide, dibenzoyl peroxide, dilauryl peroxide, cyclohexane peroxide, and methyl ethyl ketone peroxide), hydroperoxides (e.g., butyl hydroperoxide and cumene hydroperoxide), dicyclohexyl peroxydicarbonate, t-butyl perbenzoate, and azo compounds such as 2,2,-azo-bis(isobutyronitrile) (AIBN), and combinations thereof. Examples of commercially available thermal initiators include initiators available under the “VAZO” trade designation from The Chemours Company (Wilmington, DE) such as “VAZO 64” (2,2′-azobis(isobutyronitrile)), “VAZO 52”, “VAZO 65” and “VAZO 68” and initiators available under the “CELOGEN” trade designation from CelChem LLC, Naples, FL. Peroxides are available from a variety of sources.

An initiator is used in an amount effective to facilitate polymerization of the monomers present in the vehicle, and the amount will vary depending upon, for example, the type of initiator, the molecular weight of the initiator, the intended application of the resulting adhesive composition, and polymerization process factors such as temperature. The photoinitiator can be used in any amount effective to facilitate polymerization of the monomers (e.g., 0.1 part to about 5 parts, 0.2 part to about 2 parts, or about 0.1 part to about 1 part per hundred parts of the monofunctional monomers used to make the acrylic polymer).

In some embodiments, the vehicle includes a photoinitiator which can be considered a photocrosslinker. Examples of suitable photocrosslinkers include ethylenically unsaturated compounds which in the excited state are capable of abstracting hydrogen (e.g., acrylated benzophenones such as described in U.S. Pat. No. 4,737,559 (Kellen et al.)), p-acryloxybenzophenone, which is available from Sartomer Company, Exton, PA, monomers described in U.S. Pat. No. 5,073,611 (Rehmer et al.) including p-N-(methacryloyl-4-oxapentamethylene)-carbamoyloxybenzophenone, N-(benzoyl-p-phenylene)-N′-(methacryloxymethylene)-carbodiimide, and p-acryloxy-benzophenone), and para-acryloxyethoxybenzophenone; monofunctional benzophenones (e.g., benzophenone, 4-phenylbenzophenone, 4-methoxybenzophenone, 4,4′-dimethoxybenzophenone, 4,4′-dimethylbenzophenone, 4-methylbenzophenone, 4-(2-hydroxyethylthio)-benzophenone, and 4-(4-tolylthio)-benzophenone); polyfunctional benzophenones (e.g., di-esters of carboxymethoxy-benzophenone and polytetramethyleneglycol 250); anthraquinone photocrosslinkers (e.g., anthraquinone, 2-methyl anthraquinone, 2-t-butyl anthraquinone, 2-ethyl anthraquinone, 2-phenyl anthraquinone, 1,4-dimethyl anthraquinone, 2,3-dimethyl anthraquinone, 1,2-dimethyl anthraquinone, I-methoxy-2-methyl anthraquinone, 2-acetyl anthraquinone, and 2,6-di-t-butyl anthraquinone); thioxanthone photocrosslinkers (e.g., thioxanthone, 2-isopropylthioxanthone, 2-chlorothioxanthone, 2-dodecylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, I-ethoxycarbonyl-3-phenylsulfurylthioxanthone, 1-ethoxycarbonyl-3-(1-methyl-1-morpholinoethyl)-thioxanthone, 2-methyl-6-dimethoxymethylthioxanthone, 2-methyl-6-(1,1-dimethoxybenzyl)-thioxanthone, 2-morpholinomethyltbioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 6-ethoxycarbonyl-2-methoxythioxanthone; and 6-ethoxycarbonyl-2-methylthioxanthone); halomethyl-1, 3, 5-triazines (e.g., 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley); and 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley)). The photocrosslinkers may be present in the acrylic polymer in any useful amount. For example, an amount of 0.001 to 10 parts, 0.001 to 5 parts, 0.001 to 2 parts, 0.001 to 1 part, 0.001 to 0.5 part, or 0.001 to 0.1 part per hundred parts of the monofunctional monomers may be useful in a vehicle comprising at least one acrylic monomer, for example, first and second acrylic monomers as described above in any of their embodiments.

A polymerizable vehicle composition may also include a chain transfer agent. The chain transfer agent can be selected to be soluble in a monomer mixture to be polymerized. Examples of suitable chain transfer agents include triethyl silane and mercaptans.

In some embodiments of the foam composition of the present disclosure and/or made by the method of the present disclosure, the vehicle comprises or is derived from a composition comprising at least one acrylic monomer, for example, first and second acrylic monomers as described above in any of their embodiments, and a polymer prepared from the partial polymerization of the at least one acrylic monomer. The vehicle can be a solution of polymer in the at least one monomer and can be, for example, about 3 percent to 15 percent polymerized. In some embodiments, the vehicle comprises at least 75, 80, 85, 90, or 95 percent by weight monomer(s), based on the total weight of the vehicle. In some embodiments, the vehicle is exposed to ultraviolet radiation to provide the solution of the polymer in the at least one acrylic monomer. It is also possible for the solution of the polymer in the at least one acrylic monomer to be made by partial free-radical polymerization using a thermal initiator or other free-radical source.

A useful solvent-free polymerization method is disclosed in U.S. Pat. No. 4,379,201 (Heilmann et al.). Initially, a mixture of first and second monomers can be polymerized with a portion of a photoinitiator by exposing the mixture to UV radiation in an inert environment for a time sufficient to form a coatable base syrup, and subsequently adding a crosslinking agent and the remainder of the photoinitiator. The crosslinking can be, for example, any of the polyfunctional crosslinking monomers described above in any of the amounts described above. This final syrup containing a crosslinking agent (e.g., which may have a Brookfield viscosity of about 500 centipoise (cps) to about 10,000 cps at 23° C., about 100 cps to about 6000 cps at 23° C., or about 5,000 cps to about 7,500 cps at 23° C. as measured with a No. 4 LTV spindle, at 60 revolutions per minute) can then be coated onto a substrate. Once the syrup is coated onto the substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated PET film, that is transparent to UV radiation or e-beam irradiation.

Any suitable light source may be used, including fluorescent UV bulbs, mercury lamp (e.g., a low-pressure mercury lamp, a medium-pressure mercury lamp, a high-pressure mercury lamp, an ultrahigh-pressure mercury lamp), a xenon lamp, a metal halide lamp, an electrodeless lamp, an incandescent lamp, LEDs, and lasers. For broadband light sources (e.g., a fluorescent UV bulb, mercury lamp, or incandescent lamp), filters may be useful for narrowing the wavelength ranges to be within or outside the wavelength at which the ultraviolet light absorber absorbs and/or to modify the intensity of the light source.

The vehicle and/or foam composition can also include other ingredients such as curing agents, cure accelerators, catalysts, tackifiers, plasticizers, dyes, flame retardants, adhesion promoters (e.g., coupling agents such as silane coupling agents), pigments, impact modifiers, flow control agents, foaming agents, fillers (e.g., talc, zinc oxide, and fused silica), glass and polymer microspheres and microparticles, electrically conductive particles, thermally conductive particles, fibers, antistatic agents, antioxidants such as hindered phenols, amines, and sulfur and phosphorous hydroperoxide decomposers, UV absorbers, stabilizers (e.g., hindered amine light stabilizers and heat stabilizers); and viscosity adjusting agents such as fumed silica.

Foam compositions of the present disclosure and/or made by the processes of the present disclosure can include hollow microspheres (e.g., hollow ceramic (e.g., glass) microspheres or hollow polymeric microspheres such as elastomeric particles available, for example, from Akzo Nobel, Amsterdam, The Netherlands, under the trade designation “EXPANCEL”. Examples of hollow ceramic microspheres include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”), calcium carbonate-coated polyvinylidene copolymer microspheres having a specific gravity of 0.13 (“DUALITE 6001AE”, Pierce & Stevens Corp.), and glass bubbles marketed by 3M Company, Saint Paul, Minnesota, as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”. Foams that include hollow microspheres are referred to as syntactic foams. Foamed adhesives can also include a hydrocarbon elastomer as described in U.S. Pat. No. 5,024,880 (Vesley et al.).

In some embodiments, the vehicle that comprises an adhesive composition comprises a tackifier, useful for increasing the stickiness of the surface of a PSA. In some embodiments, the foam composition does not comprise a tackifier. Useful tackifiers can have a number average molecular weight of up to 10,000 grams per mole, a softening point of at least 70° C. as determined using a ring and ball apparatus, and a glass transition temperature of at least −30° C. as measured by differential scanning calorimetry. Useful tackifiers are typically amorphous. In some embodiments, the tackifier is miscible with the polymer(s) of the PSA such that macroscopic phase separation does not occur in the PSA. In some embodiments, the PSA is free of microscopic phase separation as well. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. Any of these tackifying resins may be hydrogenated (e.g., partially or completely). Examples suitable tackifiers include those obtained under the trade designations “FLORAL” including “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ” including “ESCOREZ 2520” and “ESCOREZ 5615” (aliphatic/aromatic hydrocarbon resins) commercially available from ExxonMobil Corp., Houston, TX; “ARKON” such as “ARKON P125” a fully hydrogenated hydrocarbon resin, commercially available from Arakawa Chemical Inc., Chicago, Illinois, and “REGALITE” such as “REGALITE 7100” (a partially hydrogenated hydrocarbon resin) commercially available from Eastman, Kingsport, Tennessee.

In some embodiments, the vehicle includes at least about one percent by weight and up to about 50 percent by weight of the tackifier, based on the total weight of the vehicle. In some embodiments, the tackifier is present in a range from 1 to 25, 2 to 20, 2 to 15, 1 to 10, or 3 to 10 percent by weight, based on the total weight of the vehicle.

Plasticizers may be added, e.g., to reduce vitrification of an adhesive composition. Suitable plasticizers include various polyalkylene oxides (e.g., polyethylene oxides or propylene oxides), adipic acid esters, formic acid esters, phosphoric acid esters, benzoic acid esters, phthalic acid esters, polyisobutylenes, polyolefins, and sulfonamides, naphthenic oils, plasticizing aids such as those materials described as plasticizers in the Dictionary of Rubber, K. F. Heinisch, pp. 359, John Wiley & Sons, New York (1974), oils, elastomer oligomers, and waxes. The amount of plasticizer employed, if one is employed, will depend on the nature of the plasticizer and its compatibility with the vehicle.

In some embodiments, the foam composition of the present disclosure and/or made by the processes of the present disclosure is substantially solvent free. Common organic solvents include aliphatic and alicyclic hydrocarbons (e.g., hexane, heptane, and cyclohexane), hydrocarbon solvents (e.g., benzene, toluene, xylenes, and d-limonene); acyclic and cyclic ketones (e.g., acetone, methyl ethyl ketone, and methyl isobutyl ketone, pentanone, hexanone, cyclopentanone, and cyclohexanone); ethers (e.g., diethyl ether, glyme, diglyme, diisopropyl ether, and tetrahydrofuran), esters (e.g., ethyl acetate and butyl acetate), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and alcoholic solvents (e.g., methanol, ethanol, or propanol such as isopropanol). The foam composition can be substantially free of any of these solvents. The term “substantially free” means that the foam composition can include up to 0.5, 0.1, 0.05, or 0.01 percent by weight of any of these solvents or can be free of any of these solvents. These percentages are based on the total weight of the foam composition.

In some embodiments, the vehicle includes a silane coupling agent. Examples of useful silane coupling agents include organosilanes such as alkylchlorosilanes, alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltriphenoxysilane, vinyltri(t-butoxy) silane, vinyltris(isobutoxy) silane, vinyltris(isopropenoxy) silane and vinyltris(2-methoxyethoxy) silane); N-(3-triethoxysilylpropyl) methoxyethoxyethoxy ethyl carbamate; N-(3-triethoxysilylpropyl) methoxyethoxyethoxyethyl carbamate; silane functional (meth)acrylates (e.g., 3-(methacryloyloxy) propyltrimethoxysilane, 3-acryloyloxypropyltrimethoxysilane, 3-(methacryloyloxy) propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, methacryloyloxymethyltriethoxysilane, methacryloyloxymethyltrimethoxysilane, 3-(methacryloyloxy)propyldimethylethoxysilane, and 3-(methacryloyloxy)propenyltrimethoxysilane); epoxysilanes such as 2-(3,4-epoxycyclohexyl)ethyl trimethoxysilane, 3-glycidoxypropyl methyldimethoxysilane, 3-glycidoxypropyltrimethoxysilane, 3-glycidoxypropylmethoxydimethoxysilane and 3-glycidoxypropyltriethoxysilane; and aminosilanes such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane and 3-aminopropyltriethoxysilane. The silane coupling agent can be used at a quantity of approximately 0.05 weight percent or higher or approximately 0.1 weight percent or higher and approximately 2 weight percent or lower or approximately 1 weight percent or lower relative to the total weight of the vehicle.

In some embodiments, the foam composition of the present disclosure and/or made by a process of the present disclosure further comprises a foaming agent. Useful foaming agents include physical foaming agents and chemical foaming agents, either of which may be inorganic foaming agents or organic foaming agents. Useful chemical foaming mechanisms include producing gas in situ through a chemical reaction; decomposition of a component of a composition, for example, a component that liberates gas upon thermal decomposition; evaporating a component of the composition, for example, a liquid gas; volatilizing a gas in the composition by decreasing the pressure on the composition or heating the composition; and combinations thereof.

Examples of chemical foaming agents include water and azo-, carbonate- and hydrazide-based molecules including, for example, 4,4′-oxybis(benzenesulfonyl)hydrazide, 4,4′-oxybenzenesulfonyl semicarbazide, azodicarbonamide, p-toluenesulfonyl semicarbazide, barium azodicarboxylate, azodiisobutyronitrile, benzenesulfonhydrazide, trihydrazinotriazine, metal salts of azodicarboxylic acids, oxalic acid hydrazide, hydrazocarboxylates, diphenyloxide-4,4′-disulphohydrazide, tetrazole compounds, sodium bicarbonate, ammonium bicarbonate, preparations of carbonate compounds and polycarbonic acids, and mixtures of citric acid and sodium bicarbonate, N,N′-dimethyl-N,N′-dinitroso-terephthalamide, N,N′-dinitrosopentamethylenetetramine, and combinations thereof. Water is a foaming agent useful for making a polyurethane foam. Water reacts with isocyanates to ultimately form carbon dioxide, which foams the polyurethane.

Suitable inorganic physical foaming agents include, for example, nitrogen, argon, oxygen, water, air, helium, sulfur hexafluoride, and combinations thereof.

Useful organic physical foaming agents include carbon dioxide, aliphatic hydrocarbons, aliphatic alcohols, fully and partially halogenated aliphatic hydrocarbons including, for example, methylene chloride, and combinations thereof. Examples of suitable aliphatic hydrocarbon foaming agents include members of the alkane series of hydrocarbons including, for example, methane, ethane, propane, n-butane, isobutane, n-pentane, isopentane and blends thereof. Useful aliphatic alcohols include, for example, methanol, ethanol, n-propanol, and isopropanol and combinations thereof. Suitable fully and partially halogenated aliphatic hydrocarbons include, for example, fluorocarbons, chlorocarbons, and chlorofluorocarbons and combinations thereof.

Examples of suitable halogenated (in some embodiments, fluorinated) foaming agents include methyl fluoride, perfluoromethane, ethyl fluoride, 1,1-difluoroethane (HFC-152a), fluoroethane (HFC-161), 1,1,1-trifluoroethane (HFC-143a), 1,1,1,2-tetrafluoroethane (HFC-134a), 1,1,2,2 tetrafluoroethane (HFC-134), 1,1,1,3,3-pentafluoropropane, pentafluoroethane (HFC-125), difluoromethane (HFC-32), perfluoroethane, 2,2-difluoropropane, 1,1,1-trifluoropropane, perfluoropropane, dichloropropane, difluoropropane, perfluorobutane, perfluorocyclobutane, methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124), trichloromonofluoromethane (CFC-11), dichlorodifluoromethane (CFC-12), trichloro-trifluoroethane (CFC-113), dichlorotetrafluoroethane (CFC-114), chloroheptafluoropropane, and dichlorohexafluoropropane and combinations thereof. In some embodiments, the foaming agent is not halogenated. In some embodiments, the foaming agent is not fluorinated.

The foaming agents may be used as single components, in mixtures and combinations thereof, as well as in mixtures with other co-foaming agents. A foaming agent can be added to a composition in an amount sufficient to achieve a desired foam density.

In some embodiments, the foam composition of the present disclosure and/or made by a process of the present disclosure further comprises a nucleating agent. A nucleating agent can be any conventional nucleating agent. The amount of nucleating agent to be added may be selected depending upon the desired cell size, the selected foaming agent, and the density of the vehicle. Examples of inorganic nucleating agents in small particulate form include clay, talc, silica, and diatomaceous earth.

Organic nucleating agents can decompose or react at a given temperature. One example of an organic nucleating agent is a combination of an alkali metal salt of a polycarboxylic acid with a carbonate or bicarbonate. Examples of useful alkali metal salts of a polycarboxylic acid include the monosodium salt of 2,3-dihydroxy-butanedioic acid (that is, sodium hydrogen tartrate), the monopotassium salt of butanedioic acid (that is, potassium hydrogen succinate), the trisodium and tripotassium salts of 2-hydroxy-1,2,3-propanetricarboxylic acid (that is, sodium and potassium citrate, respectively), and the disodium salt of ethanedioic acid (that is, sodium oxalate) and polycarboxylic acid such as 2-hydroxy-1,2,3-propanetricarboxylic acid, and combinations thereof. Examples of carbonates and bicarbonates include sodium carbonate, sodium bicarbonate, potassium bicarbonate, potassium carbonate, calcium carbonate, and combinations thereof. One contemplated combination is a monoalkali metal salt of a polycarboxylic acid, such as monosodium citrate or monosodium tartrate, with a carbonate or bicarbonate. It is contemplated that mixtures of different nucleating agents may be added to the vehicle. Other useful nucleating agents include a stoichiometric mixture of citric acid and sodium bicarbonate.

In some embodiments, the foam composition of the present disclosure has a foam half-life at 22° C. of at least 5 minutes, 10 minutes, 15 minutes, 20 minutes, 30 minutes, 45 minutes, or 60 minutes. In this application, the foam half-life is determined by placing about 30 grams of a one weight percent solution of the silicone MQ resin alone or in combination with a surfactant in a vehicle in 4-ounce glass jar and bubbling nitrogen through the mixture at 22° C. for five minutes while stirring the mixture with a magnetic stir bar set at a low setting using the apparatus described in the Syrup Bubbling Test in the Examples. The bubbling is stopped, and the magnetic stir bar is turned off. The foam height is measured with a ruler. The time necessary for half of the liquid to be drained from the foam (i.e., to provide half of the initial volume of liquid) is measured to provide the foam half-life.

As shown in a comparison of Examples 1 to 13 and Comparative Examples CE1 to CE12 in the Examples below, silicone MQ resins, which are reported to be defoamers or anti-foamers are surprisingly good foam stabilizers in a vehicle of acrylic monomers. In fact, the silicone MQ resins are shown to better foam stabilizers than a variety of surfactants, which would have been expected as more suitable for stabilizing foams. As shown in a comparison of Examples 11 and 12 and Comparative Examples 13 and 14 in the Examples below, silicone MQ resins, which are reported to be defoamers or anti-foamers are not detrimental to the foaming capability of certain silicone and hydrocarbon surfactants in a vehicle of acrylic monomers. In fact, the silicone MQ resins are shown to enhance the foaming capability of the surfactant in Example 12.

The present disclosure provides a process for making the foam composition of the present disclosure as described above in any of its embodiments. The process comprises introducing a foaming agent into a composition comprising the vehicle and the silicone MQ resin to form voids in the composition. The foaming agent can be any of the chemical or physical foaming agents described above. The composition can be foamed according to a variety of foaming methods including those described in, for example, U.S. Pat. No. 5,024,880 (Vesley et al.), U.S. Pat. No. 4,895,745 (Vesley et al.) and U.S. Pat. No. 4,748,061 (Vesley et al.).

The composition can be foamed by forming gas voids in the composition using a variety of mechanisms including mechanical mechanisms, chemical mechanisms, and combinations thereof. Useful mechanical foaming mechanisms include agitating (e.g., shaking, stirring, and/or whipping the composition), injecting gas into the composition, for example, inserting a nozzle beneath the surface of the composition and blowing gas into the composition, and combinations thereof. In some embodiments, introducing of the foaming agent comprises at least one of stirring the composition or injecting gas into the composition. In some embodiments, the foaming agent comprises at least one of air, nitrogen, oxygen, carbon dioxide, helium, argon, or nitrous oxide.

The foam composition of the present disclosure and/or made by a process of the present disclosure is suitable for use in a variety of applications. Representative examples of foam applications include adhesives, flotation, applications in the automotive industry including automotive body moldings, applications related to automotive glazing including gaskets and sealants, applications in the construction industry including structural components (e.g., sized lumber, shaped trim, posts, beams, and shaped structural members), lightweight ceramics including pre-cast and cast-in-place construction materials including cementitious and gypsum materials such as blocks, boards, panels, roofdecks, and flooring, landfill covers, odor barriers, dust covers, firefighting and fireproofing foams, liquid containment booms (for example, oil spill containment boom), and fillers for voids such as oil wells and tunnels and voids present in soil. Other foam applications include packaging, commercial cleaning products including cleaners for vertical cleaning applications, inks, de-inking compositions, surface coatings including, for example, foamed coatings for paper and textile treatment.

The foam compositions can also be formulated for use in medical applications including bandages and wound dressings and household and industrial applications including cups, plates, earplugs, cushions, pillows, insulation, a damper, for example, for suppressing sound, absorbing vibration (e.g., cushioning the vibration of machine covers), and combinations thereof, and baffles.

In another embodiment, the foam composition is formulated to be useful as a gasket or seal to seal an area from, for example, dust, moisture, organic vapor, and combinations thereof. Examples of sealing applications include sealing gaps between parts in computer printers, sealing electronic equipment, and sealing skylight assemblies.

The foam composition can be formulated to provide foams that are flexible and conformable and suitable for filling gaps and bonding irregular surfaces. The foam can also be formulated to provide a bond line that seals, cushions vibration, damps vibration, resists impact, withstands a wide temperature range or provides good insulating qualities or provides a combination of these properties.

The foam composition can be in the form of a tape such as a pressure-sensitive adhesive tape. Useful foam tape constructions include a foam composition disposed on a substrate, for example, a backing or a release liner, and, optionally, wound in the form of a roll. In some embodiments, the foam tape construction includes an adhesive composition disposed on a surface of a foam tape, which forms a tape having an adhesive layer on one side of the foam tape, that is, a single coated adhesive foam tape. In another embodiment, the foam composition can be in the form of a tape having an adhesive layer on two major surfaces of the foam tape, which is known as double-coated foam tape.

The present disclosure provides a process for making an adhesive tape, the process comprising applying the foam composition to a substrate. Applying the foam composition to a substrate can be carried out after it is foamed using any of the methods described above, that is, after voids are formed therein. The foam composition can be applied to the substrate using a variety of methods (e.g., dipping, spraying, brushing, roll coating, bar coating). In some embodiments, the composition can be coated on a liner with a notch bar with a gap setting to provide the desired thickness above the liner, and another liner may be added to maintain a gap of the desired thickness. Although any of the foam compositions described above in any of their embodiments can be applied to a substrate, in some embodiments, the vehicle comprises a monomer and optionally a polymer, and the process further comprises polymerizing the monomer. In some embodiments, the process further comprises crosslinking the foam composition. When polymerizing or crosslinking using a UV light source such as any of those described above is used, any useful amount of UV irradiation can be employed, such as from approximately 1,000 mJ/cm² to approximately 10,000 mJ/cm², 1,000 mJ/cm² to approximately 5,000 mJ/cm², or from approximately 1,000 mJ/cm² to approximately 3,000 mJ/cm².

Adhesive foams have a variety of useful applications including, for example, bonding two substrates together, mounting applications using articles including hooks, hangers, and holders, joining applications including adhering two or more containers, for example, boxes, together for later separation, bonding articles to surfaces, for example, walls, floors, ceilings and counters and replacing mechanical fasteners, mastics, or liquid glues. When bonding rough or irregular surfaces, the properties and formulation of the foam tape may be selected to provide a foam tape that distributes stress uniformly over the bonded area. Other adhesive foam applications include, for example, as structural adhesives and foam-in-place adhesives.

In other embodiments, the foam composition includes other components such as scrims, films, tissues, and combinations thereof, dispersed in the foam or disposed in a layered construction with the foam composition in the form of, for example, alternating layers, interpenetrating layers, and combinations thereof. Other useful foam constructions include multi-layer foam constructions that include layers of foam where the layers differ in at least one property including, for example, density and composition.

The foam composition can also be subjected to post processes including, for example, die cutting, crosslinking, and sterilization.

### SOME EMBODIMENTS OF THE DISCLOSURE

In a first embodiment the present disclosure provides a foam composition comprising: a vehicle having voids therein, wherein the vehicle comprises at least one of an organic, non-silicone containing polymer or an organic monomer, and a silicone MQ resin, wherein the foam composition comprises not more than 50 percent by weight water. In a second embodiment the present disclosure provides the foam composition of the first embodiment, wherein the foam composition comprises not more than 40, 30, 20, 10, 5, 4, 3, 2, or 1 percent by weight water. In a third embodiment the present disclosure provides the foam composition of the first or second embodiment, wherein the silicone MQ resin has an M:Q ratio of at least 0.8:1, 0.9:1, 1:1, 1.1:1, or 1.2:1. In a fourth embodiment the present disclosure provides the foam composition of any one of the first to third embodiments, wherein the silicone MQ resin has an M:Q ratio of not more then 2.5:1 or 2:1. In a fifth embodiment, the present disclosure provides the foam composition of any one of the first to fourth embodiments, wherein the silicone MQ resin is prepared by a reaction of a one or more compounds represented by formula (R)₃—Si—R¹ and one or more compounds represented by formula (R¹)₄Si, wherein each R is independently hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated-O—, —NR′—, —S—, —Si—, or combination thereof, and wherein aryl, arylene, and heterocyclylene are unsubstituted or substituted by at least one alkyl, alkoxy, halogen, or combination thereof, and wherein each R¹ is independently a hydrolyzable group. R may be other than hydrogen. R may be free of alkyleneoxy groups such as —(OR²)ₙ—OR³ groups, in which n, R², and R³ are as defined below in any of their embodiments. In a sixth embodiment, the present disclosure provides the foam composition of any one of the first to fifth embodiments, wherein the silicone MQ resin comprises alkyl groups or methyl groups. In a seventh embodiment, the present disclosure provides the foam composition of any one of the first to sixth embodiments, wherein the silicone MQ resin has a hydroxyl content in a range from 185 to 1840 milliequivalents per kilogram. In an eighth embodiment, the present disclosure provides the foam composition of any one of the first to seventh embodiments, wherein the silicone MQ resin is present in the foam composition in an amount from 0.1 weight percent to 10 weight percent, 0.1 weight percent to 5 weight percent, or 0.5 weight percent to 5 weight percent based on the total weight of the foam composition. In a ninth embodiment, the present disclosure provides the foam composition of any one of the first to eighth embodiments, further comprising a poly(alkyleneoxide)-modified polydimethylsiloxane. In a tenth embodiment, the present disclosure provides the foam composition of the ninth embodiment, wherein the poly(alkyleneoxide)-modified polydimethylsiloxane comprises repeating divalent units represented by formula II:

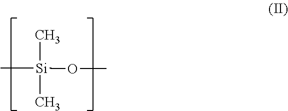

and at least one of terminal units represented by formula -Q-(OR²)ₙ—OR³ or divalent units represented by formula III:

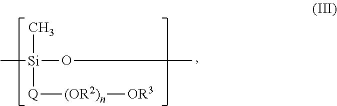

wherein each Q is independently alkylene, arylene, or alkylene that is at least one of interrupted or terminated by aryl, each of which is optionally at least one of interrupted or terminated by at least one ether, thioether, amine, amide, ester, thioester, carbonate, thiocarbonate, carbamate, thiocarbamate, urea, or thiourea, each OR² is independently —OCH₂CH₂—, —OCH(CH₃)CH₂—, —OCH₂CH₂CH₂—, —OCH₂CH(CH₃)—, —OCH₂CH₂CH₂CH₂—, —OCH(CH₂CH₃)CH₂—, —OCH₂CH(CH₂CH₃)—, and —OC(CH₃)₂CH₂—, each n is independently a value from 5 to 300, and each R³ is hydrogen, alkyl, acyl, aryl, or arylalkylenyl, wherein aryl and arylalkylenyl are unsubstituted or substituted by at least one alkyl, alkoxy, or combination thereof. In an eleventh embodiment, the present disclosure provides the foam composition of the ninth or tenth embodiment, wherein the poly(alkyleneoxide)-modified polydimethylsiloxane has a number average molecular weight of not more than 50,000 grams per mole, 40,000 grams per mole, 30,000 grams per mole, 20,000 grams per mole, or 10,000 grams per mole. In a twelfth embodiment, the present disclosure provides the foam composition of any one of the ninth to eleventh embodiments, wherein the poly(alkyleneoxide)-modified polydimethylsiloxane comprises ethyleneoxy groups, proyleneoxy groups, or a combination thereof. In a thirteenth embodiment, the present disclosure provides the foam composition of any one of the first to twelfth embodiments, further comprising an alkoxylated alcohol. In a fourteenth embodiment, the present disclosure provides the foam composition of the thirteenth embodiment, wherein the alkoxylated alcohol is an alkoxyated hydrocarbon alcohol. In a fifteenth embodiment, the present disclosure provides the foam composition of the thirteenth or fourteenth embodiment, wherein the alkoxylated alcohol is an ethoxyated hydrocarbon alcohol. In a sixteenth embodiment, the present disclosure provides the foam composition of any one of the ninth to fifteenth embodiments, wherein the silicone MQ resin and at least one of the poly(alkyleneoxide)-modified polydimethylsiloxane or the alkoxylated alcohol are present in the foam composition in a combined amount from 0.1 weight percent to 10 weight percent, 0.1 weight percent to 5 weight percent, or 0.5 weight percent to 5 weight percent based on the total weight of the foam composition.

In a seventeenth embodiment, the present disclosure provides the foam composition of any one of the first to sixteenth embodiments, wherein the vehicle comprises at least one of a thermoplastic polymer, a thermoset polymer, or an elastomer. In an eighteenth embodiment, the present disclosure provides the foam composition of any one of the first to seventeenth embodiments, wherein the vehicle comprises at least one of a polyester, a polyurethane, an amino resin, an alkyd resin, a phenolic resin, an epoxy resin, an isocyanate resin, an isocyanurate resin, or an acrylic polymer. In a nineteenth embodiment, the present disclosure provides the foam composition of any one of the first to eighteenth embodiments, wherein the vehicle comprises a crosslinked polymer. In a twentieth embodiment, the present disclosure provides the foam composition of any one of the first to nineteenth embodiments, wherein the vehicle comprises at least one of an acrylate or an acrylic polymer. In a twenty-first embodiment, the present disclosure provides the foam composition of any one of the first to twentieth embodiments, wherein the vehicle comprises at least one of isooctyl acrylate, 2-ethylhexyl acrylate, 2-propylheptyl acrylate, butyl acrylate, acrylic acid, or mixtures of at least two or at least three structural isomers of a secondary alkyl (meth)acrylate of Formula (VI):

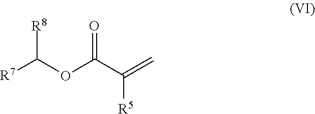

wherein R⁷ and R⁸ are each independently a C₁ to C₃₀ saturated linear alkyl group; the sum of the number of carbons in R⁷ and R⁸ is 7 to 31; and R⁵ is hydrogen or a methyl group, or a polymer comprising units of any of these. In a twenty-second embodiment, the present disclosure provides the foam composition of any one of the first to twenty-first embodiments, wherein the vehicle comprises acrylic acid and at least one of isooctyl acrylate or 2-ethylhexyl acrylate. In a twenty-third embodiment, the present disclosure provides the foam composition of any one of the first to twenty-second embodiments, wherein said vehicle comprises polyolefin. In a twenty-fourth embodiment, the present disclosure provides the foam composition of any one of the first to twenty-third embodiments, wherein the vehicle comprises at least one of a novolac resin, a resole resin, or a polyurea resin. In a twenty-fifth embodiment, the present disclosure provides the foam composition of any one of the first to twenty-fourth embodiments, wherein the vehicle comprises at least one of an isocyanate, a polyurethane, or a polyurea. In a twenty-sixth embodiment, the present disclosure provides the foam composition of any one of the first to twenty-fifth embodiments, wherein the vehicle comprises at least one of an alcohol, an aldehyde, a ketone, an ester, an ether, an amine, an amide, or a hydrocarbon.

In a twenty-seventh embodiment, the present disclosure provides the foam composition of any one of the first to twenty-sixth embodiments, wherein the vehicle has voids therein. In a twenty-eighth embodiment, the present disclosure provides the foam composition of the twenty-seventh embodiment, wherein the voids comprise at least one of air, nitrogen, oxygen, carbon dioxide, helium, argon, or nitrous oxide. In a twenty-ninth embodiment, the present disclosure provides the foam composition of any one of the first to twenty-eighth embodiments, further comprising a foaming agent. In a thirtieth embodiment, the present disclosure provides the foam composition of the twenty-ninth embodiment, wherein the foaming agent comprises at least one of air, nitrogen, oxygen, carbon dioxide, helium, argon, or nitrous oxide. In a thirty-first embodiment, the present disclosure provides the foam composition of any one of the first to thirtieth embodiments, having a foam half-life at 22° C. of at least 10 minutes. In a thirty-second embodiment, the present disclosure provides the foam composition of any one of the first to thirty-first embodiments, further comprising at least one of fumed silica, hollow ceramic microspheres, or hollow polymeric microspheres. In a thirty-third embodiment, the present disclosure provides the foam composition of any one of the first to thirty-second embodiments, wherein the foam composition is free of fluorinated surfactant.

In a thirty-fourth embodiment, the present disclosure provides the foam composition of any one of the first to thirty-third embodiments, wherein the vehicle comprises an adhesive composition. In a thirty-fifth embodiment, the present disclosure provides the foam composition of the thirty-fourth embodiment, wherein the vehicle comprises a pressure-sensitive adhesive composition. In a thirty-sixth embodiment, the present disclosure provides the foam composition of the thirty-fourth embodiment, wherein the vehicle comprises a hot melt adhesive composition. In a thirty-seventh embodiment, the present disclosure provides an adhesive tape comprising the foam composition of any one of the thirty-fourth to thirty-sixth embodiments. In a thirty-eighth embodiment, the present disclosure provides an article comprising the foam composition of any one of the first to thirty-sixth embodiments.

In a thirty-ninth embodiment, the present disclosure provides a process for making the adhesive tape of the of the thirty-seventh embodiment, the process comprising applying the foam composition to a substrate. In a fortieth embodiment, the present disclosure provides the process of the thirty-ninth embodiment, wherein the vehicle comprises the organic monomer and optionally the organic, non-silicone containing, the process further comprising polymerizing the organic monomer. In a forty-first embodiment, the present disclosure provides the process of the thirty-ninth or fortieth embodiment, further comprising crosslinking the foam composition. In a forty-second embodiment, the present disclosure provides a process for making the foam composition of any one of the first to thirty-sixth embodiments, the process comprising introducing a foaming agent into a composition comprising the vehicle and the silicone MQ resin to form voids in the composition. In a forty-third embodiment, the present disclosure provides the process of the forty-second embodiment, wherein the introducing of the foaming agent comprises at least one of stirring the composition or injecting gas into the composition. In a forty-fourth embodiment, the present disclosure provides the process of the forty-third embodiment, wherein the foaming agent comprises at least one of air, nitrogen, oxygen, carbon dioxide, helium, argon, or nitrous oxide.

The following specific, but non-limiting, examples will serve to illustrate the present disclosure.

### EXAMPLES

Unless otherwise noted, all parts, percentages, ratios, etc. in the Examples and the rest of the specification are by weight. The following abbreviations are used in this section: g=gram, cm=centimeter, Ga=gage, LPM=liters per minute, mM=millimolar, mm=millimeter, mL=milliliters, and NMR=Nuclear Magnetic Resonance. Materials used in the examples and their sources are shown in Table 1, below.

TABLE 1
Materials List

| Material | Description and Source |
|---|---|
| 2-EHA | 2-Ethylhexyl acrylate, obtained from BASF Corporation, Florham Park, NJ |
| AA | Acrylic acid, obtained from BASF Corporation |
| OMNIRAD 651 | 2,2-Dimethoxy-2-phenylacetophenone, obtained under the trade designation |
| | “OMNIRAD 651” from IGM Resins USA Inc., Charlotte, NC |
| SILMER Q9 | Silicone MQ resin, obtained under the trade designation “SILMER Q9”, from Siltech, |
| | Toronto, Ontario, Canada |
| SILMER Q12 | Silicone MQ resin, obtained under the trade designation “SILMER Q12”, from Siltech |
| SILMER Q25 | Silicone MQ resin, obtained under the trade designation “SILMER Q25”, from Siltech |
| SILMER Q20 | Silicone MQ resin, obtained under the trade designation “SILMER Q20”, from Siltech |
| SQO-299 | Silicone MQ resin, obtained under the trade designation “SQO-299”, from Gelest, |
| | Morrisville, PA |
| MQ 803 TF | Silicone MQ resin, obtained under the trade designation “MQ 803 TF”. from Wacker, |
| | Munich, Germany |
| DOWSIL MQ- | Silicone MQ resin, obtained under the trade designation “DOWSIL MQ-1600”, from |
| 1600 | The Dow Chemical Company, Midland, MI |
| SILGRIP SR545 | Silicone MQ resin, obtained under the trade designation “SILGRIP SR545”, from |
| | Momentive, Friendly, WV |
| SR1000 | Silicone MQ resin, obtained under the trade designation “SR1000”, from Momentive |
| BYK-8020 | Silicone MQ resin, obtained under the trade designation “BYK-8020”, from BYK, |
| | Wallingford, CT |
| EFKA SL 3257 | Organosilicone, obtained under the trade designation “EFKA SL 3257”, from BASF |
| SILWET L77 | Organosilicone - trisiloxane ethoxylate, obtained under the trade designation |
| | “SILWET L77”, from Momentive |
| LUTENSOL XP | C10-Guebert alcohol ethoxylate, obtained under the trade designation “LUTENSOL |
| 50 | XP 50”, from BASF |
| COATOSIL | Silicone polyether block copolymer, obtained under the trade designation |
| 7500 | “COATOSIL 7500”, from Momentive |
| VORASURF | Silicone, obtained under the trade designation “VORASURF DC 1990”, from The |
| DC 1990 | Dow Chemical Company |
| SILSENSE CP1 | PEG33 and PEG8 dimethicone and PEG14, obtained under the trade designation |
| | “SILSENSE CP1”, from Lubrizol, Wickliffe, OH |
| SILSENSE DW- | Silicone, PEG7 isostearate, obtained under the trade designation “SILSENSE DW- |
| 18 | 18”, from Lubrizol |
| SILSENSE PE | Silicone, PEG7 phosphate, obtained under the trade designation “SILSENSE PE |
| 100L | 100L”, from Lubrizol |
| SILSENSE Q | Silicone, quaternium-8, obtained under the trade designation “SILSENSE Q PLUS”, |
| PLUS | from Lubrizol |
| ULTRABEE | Silicone, PEG8 beeswax, obtained under the trade designation “ULTRABEE WD”, |
| WD | from Lubrizol |
| HYDROPALAT | Silicone, obtained under the trade designation “HYDROPALAT WE 3220”, from |
| WE 3220 | BASF |
| TEGOSTAB B | Silicone, obtained under the trade designation “TEGOSTAB B 8745”, from Evonik, |
| 8745 | Allentown, PA |
| SILUBE J208- | Silicone, alkyl polyether, 22%, obtained under the trade designation “SILUBE J208- |
| 612 | 612”, from Siltech |
| SILSURF B608 | Silicone, polyether, Mw 2000, obtained under the trade designation “SILSURF |
| | B608”, from Siltech |
| FLUROSIL | Fluorinated silicone, obtained under the trade designation “FLUROSIL TFP10000”, |
| TFP10000 | from Siltech |
| triethyl silane | Triethylsilane, from Millipore Sigma, St. Louis MO |
| Pd/Charcoal | Palladium on activated charcoal from Millipore Sigma |

### M:Q Ratio Determination

Approximately 150 mg of sample was placed into a PTFE NMR tube and dissolved with 2 mL of a 0.1 mM Cr(OAcAc)₃ in CDCl₃. Si²⁹ NMR data was collected on a 600 MHz JEOL NMR spectrometer with a 10 mm JEOL silicon free probe. M:Q ratios were determined by integrating the M region of the Si²⁹ NMR spectrum, between 17 and 5 ppm. The Q region in the Si²⁹ NMR spectrum, between −90 and −115 ppm, was also integrated. M:Q ratio is the corresponding integral ratio. The data are shown in Table 4, below.

### Poly(Alkyleneoxide)-Modified Polydimethylsiloxane Molecular Weight Determination

Approximately 150 mg of resin was placed into a PTFE NMR tube and dissolved with 2 mL of a 0.1 mM Cr(OAcAc)₃ in CDCl₃. Si²⁹ NMR data was collected on a 600 MHz JEOL NMR spectrometer with a 10 mm JEOL silicon free probe to determine number average molecular weight. Organosilicone “EFKA SL3257” was determined to have a number average molecular weight of 2135 grams per mole.

Preparation of Silicone MQ Resin Capped with Triethylsilyl Groups (TES Capped MQ Resin)

A silicone MQ resin “SQO-299” (10.0 g) was dissolved in heptane (10.0 g) followed by the addition of triethyl silane (2.0 g) in 100-mL round bottom flask. Thereafter, Pd/charcoal (0.1 g) (5.0 wt % Pd loading) was added to the above mixture at room temperature. The addition of Pd/charcoal resulted in rapid evolution of hydrogen gas signifying the substitution of silanol with triethylsilyl groups. The reaction mixture was stirred for 24 hours. The reaction mixture was passed through 0.5-micron glass filter to isolate the Pd/charcoal from reaction mixture. Finally, any unreacted triethyl silane was removed using vacuum to yield triethylsilyl capped MQ resins.

### Examples 1 to 13 (EX 1 to EX 13) and Comparative Examples (CE 1 to CE 12) for Foam Column Screen Test

In a tall glass sample vial, 0.20 g of a silicone MQ resin (as shown in Table 4, below) was measured and added for EX 1 to EX 10 and EX 13. For CE 1 to CE 12, 0.20 g of a surfactant indicated in Table 4, below, was added to a sample vial. For EX 11 and EX 12, 0.2 g of a 50:50 mixture of the silicone MQ resin and the surfactant indicated in Table 4, below, was added to a sample vial. 10.0 g of acrylic monomer mixture (90 parts by weight 2-EHA: 10 parts by weight AA) was then added to the sample vial. The sample vial was capped and then evaluated using the Foam Column Screening Test described below. The data are shown in Table 4, below.

### Foam Column Screening Test (Manually Agitated)

The prepared samples of acrylic monomer mixtures containing Examples 1 to 13 and Comparative Examples CE 1 to CE 12 were fully combined by shaking the sample vial vigorously for 15 seconds and allowing contents to settle. The sample vial was then placed on a level surface. Foam height was measured visually using a ruler. Photos were taken, and data was recorded immediately to document foamed column height. The time necessary for half of the liquid to be drained from the foam (i.e., to provide half of the initial volume of liquid) was measured and is reported as the foam half-life. The overall assessment is further described in Table 2, below.

TABLE 2
Overall Assessment of Foam Height and Foam Persistence

| Rating | 0 | 1 | 2 | 3 | 4 | 5 |
|---|---|---|---|---|---|---|
| Description | Heterogeneous | ~1 layer | Slightly | Moderate | Substantial | High foam, |
| | and/or no | of bubbles | more | foam, not | foam, | persistent |
| | foam | | bubbles | persistent | persistent | |
| Height (cm) | 23-25 | 26-28 | 29-32 | 33-36 | 37-40 | 41+ |
| (liquid + | | | | | | |
| foam) | | | | | | |
| Height foam | 0-2 | 3-5 | 6-9 | 10-13 | 14-17 | 18+ |
| only (cm) | | | | | | |
| Foam Half- | <1 | <1 | <2 | <4 | 5 to 14 | 15+ |
| Life (min) | | | | | | |

### Examples 1A to 13A (EX 1A to EX 13A) and Comparative Examples (CE 1A to CE 12A) for Syrup Bubbing Test

Coatable viscosity syrup polymers were prepared by charging a one-quart jar with 90 parts of 2-EHA and 10 parts of AA and “OMNIRAD 651” (0.04 parts per hundred parts of monomers), and stirred until the photoinitiator had dissolved and a homogeneous mixture was obtained. The mixture was degassed by introducing nitrogen gas into it through a tube inserted through an opening in the jar's cap and bubbling vigorously for at least 5 minutes. While stirring, the mixture was exposed to UV-A light until a pre-adhesive syrup having a viscosity deemed suitable for coating was formed. Following UV exposure, air was introduced into the jar. The light source was an array of LEDs having a peak emission wavelength of 365 nm.

In a 4 oz. glass jar equipped with a magnetic stir bar, 30.0 g of the syrup was measured. 0.30 g a silicone MQ resin (as shown in Table 4, below) was then added to the glass jar for EX 1A to EX 10A and EX 13A. For CE 1A to CE 12A, 0.30 g of a surfactant indicated in Table 4, below was added to a glass jar. For EX 11A and EX 12A, 0.30 g of a 50:50 mixture of the silicone MQ resin and the surfactant indicated in Table 4, below, was added to a glass jar. The sample was then capped. The sample was stirred on a magnetic stir plate for five minutes and then subjected to the Syrup Bubbling Test described below. The data are shown in Table 4, below.

### Syrup Bubbling Test

The bubbling apparatus was set up. A house nitrogen line was connected to a Cole-Palmer 5 LPM flow meter. The flow meter was connected to tubing equipped with a long 18 Ga needle. The prepared sample glass jar lid was replaced with a glass adaptor-equipped lid, in which the glass adapter is a hollow tube affixed through a hole in the standard jar lid. A septum was inserted into the glass adaptor, along with a 16 Ga needle (for venting). The long 18 Ga needle was then inserted into the septum. The nitrogen was then turned on and the flow was adjusted to 4 LPM and the venting needle was verified to be functional. The magnetic stir bar was then stirred with the “low” setting on a magnetic stir plate. The long needle was then pushed to the bottom of the jar. The apparatus was let to bubble for five minutes. The needle was then removed and the magnetic stir bar was turned off. The closed glass jar lid was then reapplied and the glass jar was allowed to sit at surface level.

Foam height was measured visually using a ruler. Photos were taken, and data was recorded immediately to document foamed column height and persistence. The time necessary for half of the liquid to be drained from the foam (i.e., to provide half of the initial volume of liquid) was measured and is reported as the foam half-life. The overall assessment is shown in Table 3, below.

TABLE 3
Foam Height and Foam Persistence for Syrup Bubbling Test

| Rating | 0 | 1 | 2 | 3 | 4 | 5 |
|---|---|---|---|---|---|---|
| Description | Heterogeneous | Scattered | Slightly | Moderate | Substantial | High foam, |
| | and/or no | bubbles | more | foam, | foam, | persistent |
| | foam | throughout | bubbles | quickly | slowly | |
| | | bulk | throughout | phase | phase | |
| | | | bulk | separates | separates | |
| Height (cm) | <35 | 35-40 | 41-45 | 45-60 | 45-60 | 53-75 |
| (liquid + | | | | | | |
| foam) | | | | | | |
| Foam Half- | n.a. | n.a. | n.a. | <15 | 15-59 | 60+ |
| Life (min) | | | | | | |

n.a. = not applicable because so little foam was produced

Various modifications and alterations of this disclosure may be made by those skilled the art without departing from the scope and spirit of the disclosure, and it should be understood that this invention is not to be unduly limited to the illustrative embodiments set forth herein.

TABLE 4
Examples EX 1 to EX 13 and EX 1A to EX 13A and Comparative Examples
CE 1 to CE 12 and CE 1A to CE 12A Compositions and Results

| | | | Manually | |
|---|---|---|---|---|
| | | M:Q | Agitated | Syrup Bubbling |
| Example | Additive | Ratio | Rating | Rating |
| EX 1, EX 1A | SQO-299 | 0.9:1 | 5 | 4 |
| EX 2, EX 2A | SILMER Q12 | 1.2:1 | 5 | 3 |
| EX 3, EX 3A | SILMER Q20 | 1.6:1 | 5 | 5 |
| EX 4, EX 4A | SILMER Q25 | 1.7:1 | 5 | 5 |
| EX 5, EX 5A | MQ 803 TF | 0.7:1 | 4 | 3 |
| EX 6, EX 6A | BYK-8020 | 0.5:1 | 4 | 3 |
| EX 7, EX 7A | DOWSIL MQ-1600 | 0.8:1 | 4 | 3 |
| EX 8, EX 8A | SILGRIP SR545 | 0.8:1 | 4 | 3 |
| EX 9, EX 9A | SR1000 | 0.7:1 | 4 | 3 |
| EX 10, EX 10A | SILMER Q9 | 0.9:1 | 4 | 3 |
| EX 11, EX 11A | BYK-8020 + EFKA SL 3257 | 0.5:1 | 4 | 4 |
| EX 12, EX 12A | BYK-8020 + LUTENSOL XP 50 | 0.5:1 | 4 | 4 |
| EX 13, EX 13A | TES-capped MQ Resin | 0.9:1 | 4 | 4 |
| CE 1, CE 1A | COATOSIL 7500 | n.a.^{a} | 1 | 1 |
| CE 2, CE 2A | VORASURF DC 1990 | n.a.^{a} | 1 | 1 |
| CE 3, CE 3A | SILSENSE CP1 | n.a.^{a} | 1 | 0 |
| CE 4, CE 4A | SILSENSE DW-18 | n.a.^{a} | 1 | 1 |
| CE 5, CE 5A | SILSENSE PE 100L | n.a.^{a} | 1 | 0 |
| CE 6, CE 6A | SILSENSE Q PLUS | n.a.^{a} | 1 | 1 |
| CE 7, CE 7A | ULTRABEE WB | n.a.^{a} | 0 | 0 |
| CE 8, CE 8A | HYDROPALAT WE 3220 | n.a.^{a} | 0 | 0 |
| CE 9, CE 9A | TEGOSTAB B 8745 | n.a.^{a} | 0 | 0 |
| CE 10, CE 10A | SILUBE J208-612 | n.a.^{a} | 0 | 0 |
| CE 11, CE 11A | SILSURF B608 | n.a.^{a} | 0 | 0 |
| CE 12, CE 12A | FLUROSIL TFP10000 | n.a.^{a} | 0 | 0 |
| CE 13, CE 13A | EFKA SL3257 | n.a.^{a} | 4 | 4 |
| CE 14, CE 14A | LUTENSOL XP 50 | n.a.^{a} | 3 | 2 |

^{a}n.a. = not applicable

1. A foam composition comprising:
a vehicle having voids therein, wherein the vehicle comprises at least one of an organic, non-silicone containing polymer or an organic monomer; and
a silicone MQ resin,
wherein the foam composition comprises not more than 50 percent by weight water.

2. The foam composition of claim 1, wherein the silicone MQ resin has an M:Q ratio of at least 0.8:1.

3. The foam composition of claim 1, wherein the MQ resin comprises methyl groups and has a hydroxyl content in a range from 185 to 1840 milliequivalents per kilogram.

4. The foam composition of claim 1, wherein the silicone MQ resin is present in the foam composition at a level from 0.1 to 10 weight percent based on the total weight of the foam composition.

5. The foam composition of claim 1, further comprising a poly(alkyleneoxide)-modified polydimethylsiloxane, which has a number average molecular weight of not more than 50,000 grams per mole, and wherein the alkylene oxide comprises ethyleneoxy groups, propyleneoxy groups, or a combination thereof.

6. The foam composition of claim 1, further comprising an ethoxylated alcohol.

7. The foam composition of claim 1, having a foam half-life at 22° C. of at least 10 minutes.

8. The foam composition of claim 1, further comprising at least one of fumed silica, hollow ceramic microspheres, or hollow polymeric microspheres.

9. The foam composition of claim 1, wherein the vehicle comprises the organic, non-silicone containing polymer, and wherein the organic, non-silicone containing polymer comprises at least one of a polyester, a polyurethane, a polyurea, an amino resin, an alkyd resin, a phenolic resin, an epoxy resin, an isocyanate resin, an isocyanurate resin, or an acrylic polymer.

10. The foam composition of claim 1, wherein the vehicle comprises the organic, non-silicone containing polymer, and wherein the organic, non-silicone containing polymer is crosslinked.

11. The foam composition of claim 1, wherein the vehicle comprises at least one of an acrylate or an acrylic polymer.

12. The foam composition of claim 1, wherein the vehicle comprises at least one of isooctyl acrylate, 2-ethylhexyl acrylate, 2-propylheptyl acrylate, butyl acrylate, acrylic acid, mixtures of at least two or at least three structural isomers of a secondary alkyl (meth)acrylate of Formula: 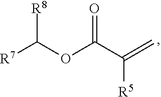
or a polymer comprising units of at least one of isooctyl acrylate, 2-ethylhexyl acrylate, 2-propylheptyl acrylate, butyl acrylate, acrylic acid, or mixtures of at least two or at least three structural isomers of a secondary alkyl (meth)acrylate of Formula: 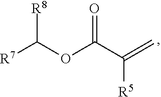
wherein R⁷ and R⁸ are each independently a C₁ to C₃₀ saturated linear alkyl group; the sum of the number of carbons in R⁷ and R⁸ is 7 to 31; and R⁵ is hydrogen or a methyl group.

13. The foam composition of claim 1, wherein the vehicle comprises an adhesive composition.

14. An adhesive tape comprising the foam composition of claim 13.

15. A process for making the foam composition of claim 1, the process comprising introducing a foaming agent into a composition comprising the vehicle and the silicone MQ resin to form voids in the composition.
